(19) United States
(12) Patent Application Publication
(10) Pub. No.: US 2017/0017332 A1
(43) Pub. Date: Jan. 19, 2017

(54) TOUCH FILM AND TOUCH MODULE WITH THE SAME

(71) Applicant: HON HAI PRECISION INDUSTRY CO., LTD., New Taipei (TW)

(72) Inventors: YI-SHENG LIN, New Taipei (TW); KUO-HSIEN WU, New Taipei (TW)

(21) Appl. No.: 14/826,755

(22) Filed: Aug. 14, 2015

(30) Foreign Application Priority Data
Jul. 16, 2015 (CN) 201510417779.1

(51) Int. Cl. G06F 3/041

(52) U.S. Cl. CPC G06F 3/0416

(57) ABSTRACT

A touch film includes a main body. The main body has a top surface. A recess is defined in the top surface of the main body and configured to be found by a tactile feeling of a finger of a user. A touch module with the touch film is also provided in the present disclosure.

### CROSS-REFERENCE TO RELATED APPLICATIONS

This application claims priority to Chinese Patent Application No. 201510417779.1 filed on Jul. 16, 2015, the contents of which are incorporated by reference herein.

### FIELD

The subject matter herein generally relates to a touch film and a touch module with the touch film.

### BACKGROUND

An electronic product with a visual region configured for users to watch and a controlling region configured for users to touch and control the electronic product, however, when users need to control the electronic product, users must watch the controlling region to touch the controlling region, it causes users cannot continually watch the visual region.

### BRIEF DESCRIPTION OF THE DRAWINGS

Implementations of the present technology will now be described, by way of example only, with reference to the attached figures.

FIG. 1 is a top view showing a touch film in accordance with a first embodiment of the present disclosure.

FIG. 2 is a cross sectional view of the touch film of FIG. 1, taken along line II-II thereof.

FIG. 3 is a diagrammatic view of an electronics product with the touch film of FIG. 1 in accordance with a first embodiment of the present disclosure.

FIG. 4 is a diagrammatic view of an electronics product with the touch film of FIG. 1 in accordance with a second embodiment of the present disclosure.

FIG. 5 is a diagrammatic view of an electronics product with the touch film of FIG. 1 in accordance with a third embodiment of the present disclosure.

FIG. 6 is a perspective view show the touch film in accordance with a second embodiment of the present disclosure.

FIG. 7 is a top view of the touch film of FIG. 6.

FIG. 8 is a cross sectional view of the touch film of FIG. 6, taken along line VIII-VIII thereof.

FIG. 9 is a cross sectional view of the touch film of FIG. 6, taken along line IX-IX thereof.

FIG. 10 is a diagrammatic view of a touch module with the touch film in accordance with a first embodiment of the present disclosure.

FIG. 11 is a diagrammatic view of a touch module with the touch film in accordance with a second embodiment of the present disclosure.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. The description is not to be considered as limiting the scope of the embodiments described herein.

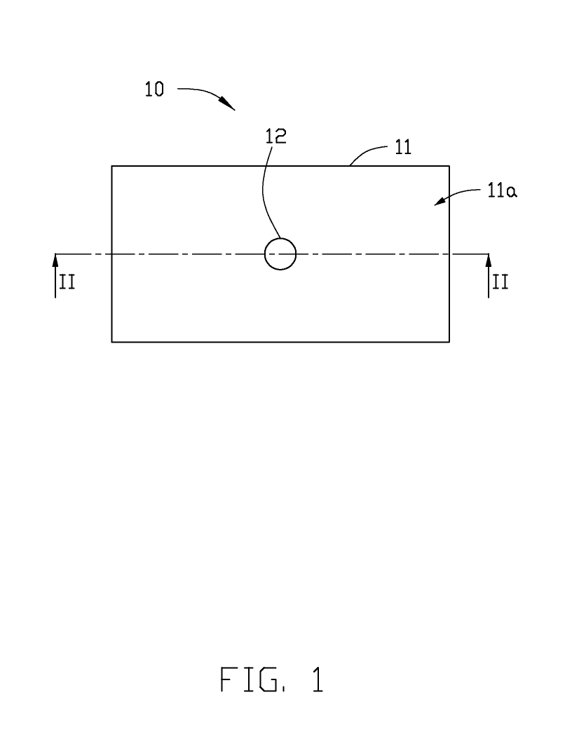

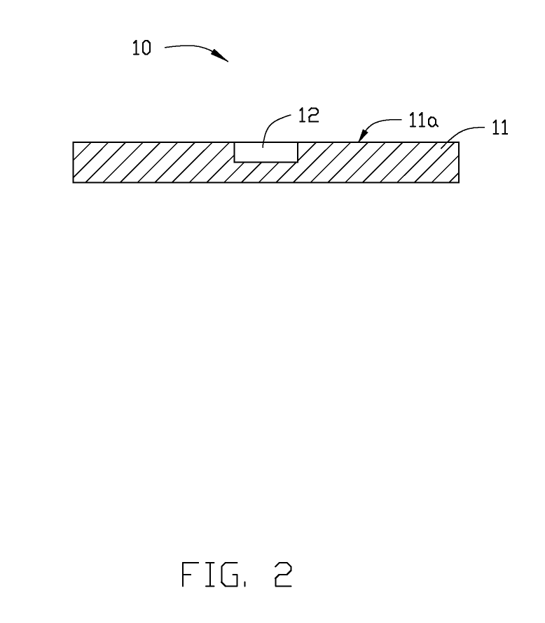

Referring to FIG. 1-2, a touch film 10 is provided in the present disclosure. The touch film 10 includes a main body 11 and a recess 12 defined in a top surface 11a of the main body 11. A shape, a size or the number of the recess 12 can be decided according to the actual needs.

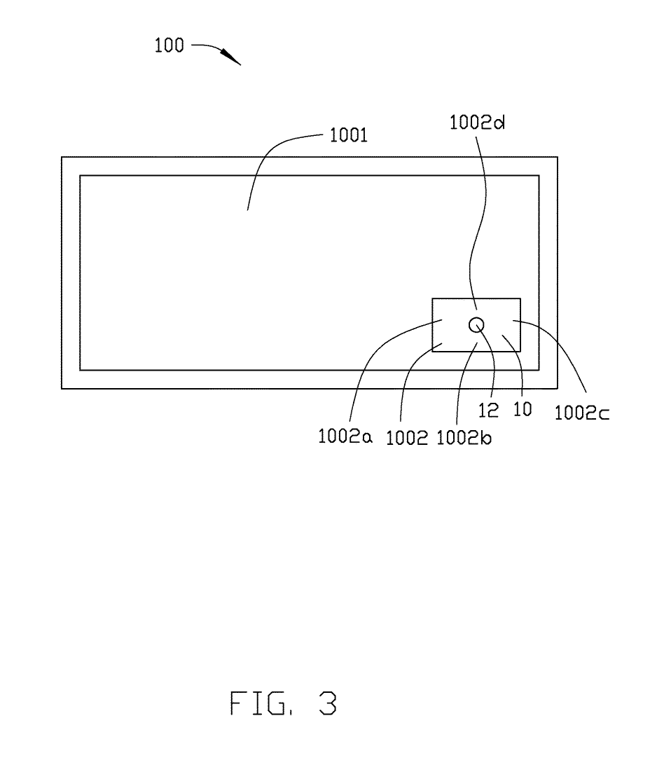

Referring to FIGS. 3-5, an electronics product includes a visual region 1001 and a controlling region 1002. Users can watch a view or a controlled object in the visual region 1001. Users can control the electronics product 100 by touch the controlling region 1002 of the electronics product 100.

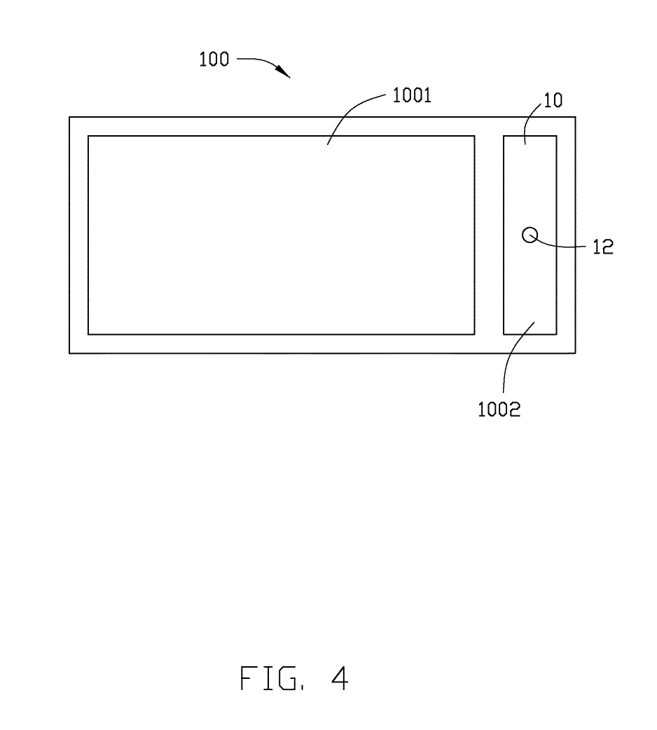

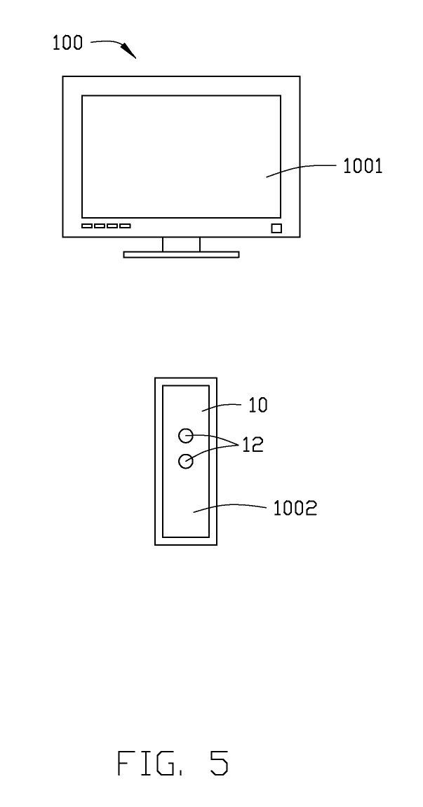

The touch film 10 is arranged on the controlling region 1002. The recess 12 is found by a tactile feeling of a finger of a user. The recess 12 can be functioned as a positional reference point of switching or selecting different function areas, such as four areas labeled by 1002a, 1002b, 1002c and 1002d showing in FIG. 3, and controlling the electronics product 100. Referring to FIG. 3, the electronics product 100 can be a mobile phone with a touch screen or a handheld game console with a touch screen. Referring to FIG. 4, the electronics product 100 can be a tablet personal computer or a household appliance with a touch screen. Referring to FIG. 5, the electronics product 100 can be a television and a controller with a touch screen for controlling the television.

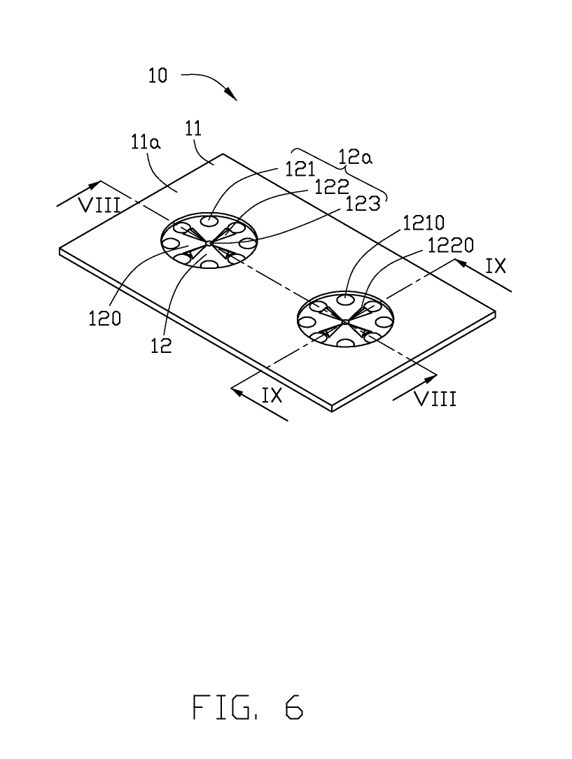

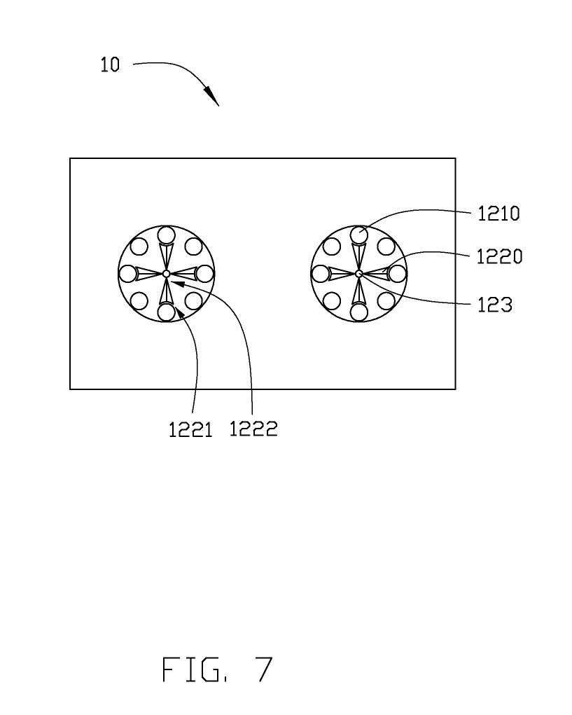

Referring to FIGS. 6-7, the recess 12 can further include a plurality of controlling units 12a formed on a bottom surface 120 of the recess 12. In at least one embodiment, the controlling units 12a can include a first controlling unit 121, a second controlling unit 122 and a third controlling unit 123. The first controlling unit 121 can be arranged to surround the second controlling unit 122 and the third controlling unit 123. The second controlling unit 122 can be arranged to surround the third controlling unit 123.

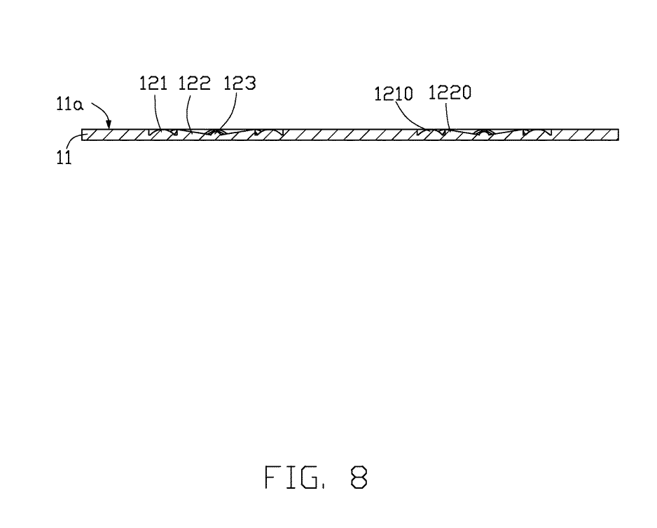

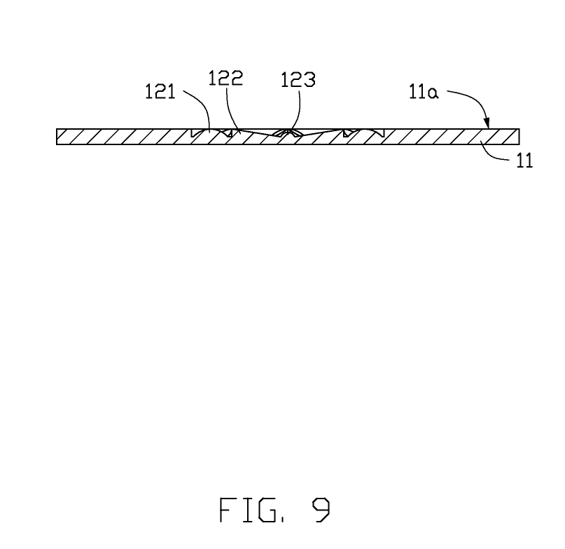

Referring to FIGS. 8-9, the first controlling unit 121 includes a plurality of first controlling elements 1210. The first controlling elements 1210 are spaced from each other. Each first controlling element 1210 is formed on a bottom surface 120 of the recess 12. Each first controlling element 1210 can be a bump. The first controlling elements 1210 are arranged to adjacent to and around an edge of the bottom surface 120 of the recess 12. Each first controlling element 1210 can be a hemispheroid. In this embodiment, the plurality of the first controlling elements 1210 numbers eight. The first controlling elements 1210 are arranged as a ring. In other embodiments, the plurality of the first controlling elements 1210 can number four or twelve.

The second controlling unit 122 includes a plurality of second controlling elements 1220. The second controlling elements 1220 are spaced from each other. Each second controlling element 1220 is formed on a bottom surface 120 of the recess 12. Each second controlling element 1220 can be a bump. In this embodiment, the plurality of the second controlling elements 1220 can number four. The plurality of the first controlling elements 1210 number greater than or equal to the plurality of the second controlling elements 1220.

Each second controlling element 1220 has a first end 1221 and a second end 1222 opposite to the first end 1221. The first end 1221 faces the first controlling unit 121, and the second controlling unit 122 faces the third controlling unit 123. For illustration purposes, an extending direction of one second controlling element 1220 is defined as a direction as one moves away from the second end 1222 to the first end 1221. Extending directions of the fourth second controlling elements 1220 have 90 degrees therebetween. Each second controlling element 1220 can be a triangular. The first end 1221 is a base of the second controlling element 1220, and the second end 1222 is at a vertex of the second controlling element 1220.

The third controlling unit 123 is positioned at a center of the second controlling unit 122. The third controlling unit 123 is formed on a bottom surface 120 of the recess 12. The third controlling unit 123 can be a bump. In at least one embodiment, the third controlling unit 123 can be a hemispheroid.

A height of the first controlling elements 1210, a height of the second controlling elements 1220 and a height of the third controlling unit 123 is less than a depth of the recess 12.

In using the touch film 10, the touch film 10 is coupled with a touch sensor. When a finger of a user touches one first controlling element 1210 of the first controlling unit 121, one second controlling element 1220 of the second controlling unit 122 or/and the third controlling unit 123, the touch sensor can sense a signal from the touch film 10 and control the electronics product 100. For example, if the third controlling unit 123, one second controlling element 1220 of the second controlling unit 122 and one first controlling element 1210 of the first controlling unit 121 is successively touched by the finger of the user, the touch sensor can sense a “move” signal; if the third controlling unit 123 is touched just one time and the second controlling unit 122 and third controlling unit 123 is not touch, the touch sensor can sense a “confirm” signal; if the third controlling unit 123 is touch two times continually and quickly, the touch sensor can sense a “adjust” signal.

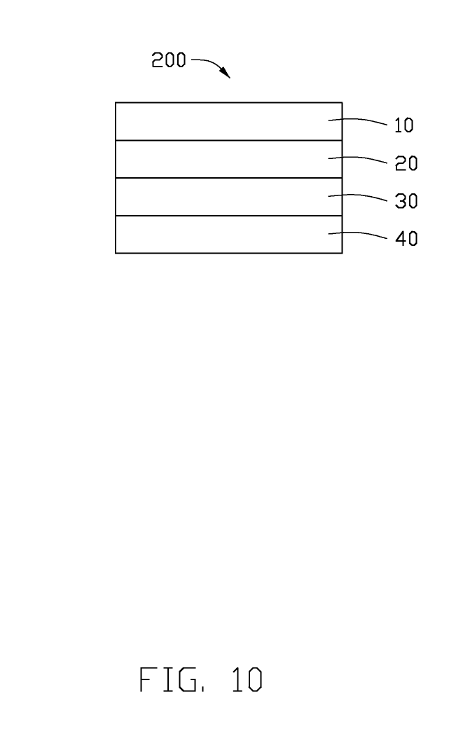

Referring to FIG. 10, a touch module 200 is provided in the present disclosure. The touch module 200 includes a base 40, a touch sensor 30, an adhesive layer 20 and a touch film 10. The touch sensor 30, the adhesive layer 20 and the touch film 10 are stacked successively on the base 40.

The base 40 is a plate. The base 40 can be made of glass or organic material. The base 40 can be a hard film or a flexible film.

The touch sensor 30 is stacked on the base 40. The touch sensor 30 can include a plurality of capacitors, inducers and chips.

The adhesive layer 20 is stacked on the touch sensor 30. The adhesive layer 20 bonds the base 40 and the touch film 10. The adhesive layer 20 can be made of optically clear adhesive (OCA) or optically clear resin (OCR).

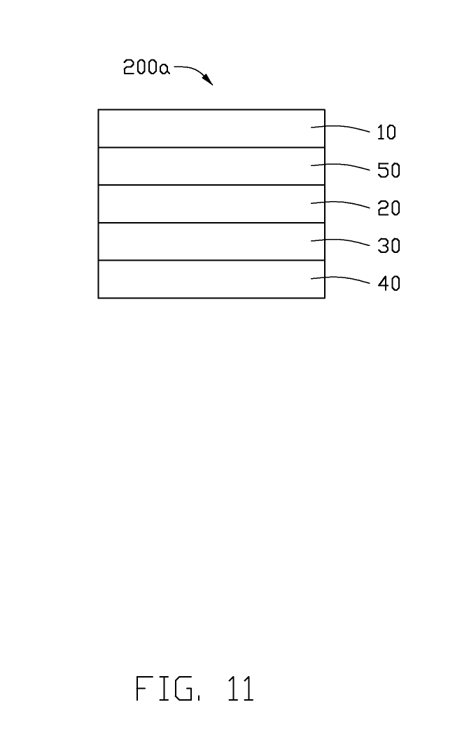

Referring to FIG. 11, a touch module 200a is provided. The touch module 200a is similar to the touch module 200, but further includes a protecting layer 50. The protecting layer 50 is arranged between the adhesive layer 20 and the touch film 10. The adhesive layer 20 bonds the touch sensor 30 and the protecting layer 50. The protecting layer 50 can be made of glass or organic material. The protecting layer 50 can be a hard film or a flexible film.

The touch film 10 can be coupled with the protecting layer 50 by an adhesive. And, the touch film 10 can be fastened to the protecting layer 50.

The embodiments shown and described above are only examples. Many details are often found in the art such as the other features of a touch film and a touch module with the touch film. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A touch film comprising:
a main body having a top surface; and
the top surface of the main body defining a recess configured to be found by a tactile feeling of a finger of a user.

2. The touch film of claim 1, wherein the recess comprises a plurality of controlling units formed on a bottom surface of the recess.

3. The touch film of claim 2, wherein the recess comprises a first controlling unit, a second controlling unit and a third controlling unit.

4. The touch film of claim 3, wherein the first controlling unit is arranged to surround the second controlling unit and the third controlling unit.

5. The touch film of claim 3, wherein the second controlling unit is arranged to surround the third controlling unit.

6. The touch film of claim 3, wherein the first controlling unit comprises a plurality of first controlling elements spaced from each other.

7. The touch film of claim 6, wherein each first controlling element is a bump.

8. The touch film of claim 6, wherein the second controlling unit comprises a plurality of second controlling elements spaced from each other.

9. The touch film of claim 8, wherein each second controlling element is a bump.

10. The touch film of claim 9, wherein the plurality of the first controlling elements is larger than or equal to the plurality of the second controlling elements.

11. The touch film of claim 8, wherein each second controlling element has a first end and a second end opposite to the first end, the first end faces the first controlling unit, and the second controlling unit faces the third controlling unit.

12. The touch film of claim 11, wherein extending directions of the fourth second controlling elements have 90 degrees therebetween.

13. The touch film of claim 8, wherein each second controlling element is a triangular.

14. The touch film of claim 8, wherein a height of the first controlling elements, a height of the second controlling elements and a height of the third controlling unit is less than a depth of the recess.

15. The touch film of claim 3, wherein the third controlling unit is a bump.

16. The touch film of claim 3, wherein the first controlling elements are arranged as a ring.

17. A touch module comprising:
a base;
a touch sensor stacked on the base;
an adhesive layer stacked on the touch sensor; and
a touch film stacked on the adhesive layer comprising:
a main body having a top surface; and
the top surface of the main body defining a recess configured to be found by a tactile feeling of a finger of a user.

18. The touch module of claim 17, wherein the recess comprises a plurality of controlling units formed on a bottom surface of the recess.
